(19) United States
(12) Patent Application Publication
(10) Pub. No.: US 2019/0277314 A1
(43) Pub. Date: Sep. 12, 2019

(54) VALVE BODY FOR A SERVOVALVE

(71) Applicant: Hamilton Sundstrand Corporation, Charlotte, NC (US)

(72) Inventors: Piotr SAWICKI, Bogdaniec (PL); Marcin CIS, Lutynia (PL)

(21) Appl. No.: 16/286,797

(22) Filed: Feb. 27, 2019

(30) Foreign Application Priority Data
Mar. 8, 2018 (EP) 18461531.8

(51) Int. Cl. F15B 13/16

(52) U.S. Cl. CPC F15B 13/16

(57) ABSTRACT

A valve body for a servovalve is provided, the valve body comprising: a first surface; a second surface offset from the first surface; a first passage extending through the body between the first and second surfaces from a first side of the body to a second side thereof; a second passage extending from the first surface towards the second surface and intersecting the first passage; a supply port joined with the first passage; a control port joined with the first passage; a return port joined with the first passage, wherein the return port comprises a third passage extending through the body between the first and second surfaces from a third side of the body to a fourth side thereof and intersecting with the first passage.

### FOREIGN PRIORITY

This application claims priority to European Patent Application No. 18461531.8 filed Mar. 8, 2018, the entire contents of which is incorporated herein by reference.

### TECHNICAL FIELD

The present disclosure relates to servovalves and more specifically to servovalves for use in aircraft air management systems.

### BACKGROUND

Servovalves may typically be used to control air or other fluid flow. Single stage pneumatic servovalves for example can be used to control the flow of fluids such as air in aircraft air management systems. Examples of such systems are engine bleed systems and cabin air conditioning systems.

A servovalve for controlling the flow of fluid typically comprises a first subsystem comprising a torque motor which acts as a driver to a second subsystem. The second subsystem comprises a valve mechanism which may control flow of the fluid. In one example, the torque motor may operate to position a moveable member, such as a flapper, in response to an input drive signal or control current, to open or close ports within the valve mechanism thus controlling flow of fluid through the ports.

Depending on its location and use, for example in an aircraft management system, a servovalve of the type described above may be exposed to fluid containing a high proportion of particulate contaminants. For example, in an aircraft management system, a servovalve may be exposed to air containing dust, for example, sand particles. A typical servovalve for controlling fluid flow of the type known in the art may comprise a return port which is in line with a direction of fluid flow through the valve system. Because of this, when used for example in an aircraft management system, air containing contaminants may flow into the valve system via the return port. This can cause build-up of the contaminants within the valve system and a consequent reduction in effectiveness of the valve.

A possible solution would be to provide a filter across the return valve to stop contaminants from entering the valve system via the return valve. However, provision of such a filter would cause flow resistance within the valve system, thus reducing the efficacy thereof.

The present disclosure seeks to address these challenges.

### SUMMARY

According to an aspect of the present disclosure there is provided a valve body for a servovalve. The valve body includes a first surface, a second surface offset from the first surface, a first passage extending through the body from a first side of the body to a second side thereof and located between the first and second surfaces and a second passage extending from the first surface towards the second surface and intersecting the first passage. The valve body also includes a supply port joined with the first passage, a control port joined with the first passage, and a return port joined with the first passage. The return port comprises a third passage extending through the body from a third side of the body to a fourth side thereof, and wherein the third passage is located between the first and second surfaces and intersects with the first passage.

Thus it will be seen by those skilled in the art that, in accordance with the present disclosure, the return port includes a third passage which extends through the valve body and will intersect the first passage at an angle. Thus, any contaminants entering the return port will be unlikely to flow into the first passage from the third passage, thus reducing the risk of contaminants entering the valve body via the return port building up in the first passage and adversely impacting on the operation of the servovalve. In addition, as the third passage of the return port extends across the valve body, any contaminant entering the return port may flow straight along the third passage and exit the valve body at a far end thereof.

The first, second and/or third passages could take any required form. For efficient flow therethrough, the first passage and/or the second passage and/or the third passage is preferably substantially straight. Further, the passages could have many possible cross sectional shapes. For ease of manufacturing and efficiency of flow therethrough, any or all of the first, second and third passages may preferably have a circular cross section and, more preferably, may be cylindrical.

The third passage could extend at less than 90° to the second passage. Preferably however, in any example of the present disclosure, the first passage extends about a first axis, the second passage extends about a second axis and the third passage extends about a third axis, and the first axis and the third axis are located in parallel planes.

In any example of the present disclosure, the third passage preferably intersects the first passage at an angle of between 45° and 135°. In any example of the present disclosure, the third passage could comprise a first straight portion extending from the third side of the body to the first passage and joining the first passage at an angle of between 45° and 135° and a second straight portion extending from the first passage to the fourth side of the body and joining the first passage at an angle of between 45° and 135° such that the third passage is bent back on itself on either side of the first passage. For ease of manufacture and improved fluid flow however, in any example of the present disclosure, the third passage may preferably comprise a single straight portion extending from the third side of the body, across the first passage to the fourth side of the body. It will be understood that in this example, the third passage will join the first passage on a first side thereof at an angle x of between 45° and 135°. The third passage will extend away from a second opposite side of the first passage at an angle of 180°-x.

In any example of the present disclosure to provide improved performance, the third passage more preferably intersects the first passage at an angle of between 75° and 105° and still more preferably intersects the first passage at an angle of between 85° and 95°. In any example of the present disclosure, the third passage more preferably intersects the first passage substantially perpendicular thereto.

In any example of the present disclosure, the first passage is preferably sealed from an external environment at the first and second sides of the body. It will be understood that no contaminants may enter the first passage through the sealed ends thereof, thus reducing the likelihood of contaminants adversely affecting operation of the servovalve as contaminants may not flow directly into the first passage from the external environment.

In any example of the present disclosure, a flow orifice having a smaller diameter than a diameter of the first passage may be provided in the first passage between the second and third passages, and a first cross sectional flow area of the third passage may preferably be at least ten times greater than a cross sectional area of the flow orifice.

In any example of the present disclosure, the third passage preferably comprises: a first portion extending between the third side of the body and the first passage and having a first cross sectional flow area; a second portion extending across the first passage; and a third portion extending between the first passage and the fourth side of the body and having the first cross sectional flow area. In this example, a second cross sectional flow area in at least part of the second portion is less than the first cross sectional flow area.

The second cross sectional area being less than the first cross sectional area may have the effect of increasing flow velocity through the second portion and so reducing pressure in the first passage adjacent the second portion. As is described further below, this will reduce the likelihood of any contaminants flowing through the third passage entering the first passage.

It will be understood that the second cross sectional flow area could be formed in a number of ways such as, for example, machining the second portion of the third passage with a cross section corresponding to the second cross sectional flow area. In any example of the present disclosure however, an obstruction preferably protrudes from the first passage across part of the second portion of the third passage so as to reduce a cross sectional flow area in the second portion of the third passage to the second cross sectional flow area. The provision of an obstruction in this manner provides a simple means of providing the reduced second cross sectional flow area in the second portion without having to manufacture a third passage having a different cross sectional area in the second portion thereof.

In any example of the present disclosure, the control port is preferably in line with the second passage.

In any example of the present disclosure, the valve body further comprises: a first nozzle provided in the first passage between the supply port and the control port; and a second nozzle provided in the first passage, a first end of the second nozzle being adjacent to the control port and a second end of the second nozzle protruding from the first passage into the third passage.

It will be understood that this allows the protruding part of the second nozzle to provide the protrusion which reduces the cross sectional flow area of the second portion of the third passage. As the first and second nozzles may also serve other uses within the valve body, this provides a simple and efficient solution.

From a further aspect, the present disclosure provides a servovalve comprising: a torque motor; and a valve body as in any prior embodiment.

The servovalve may preferably further comprise a valve member movable between a first position to open the supply port, control port and return port, a second position to close the supply port, a third position to open the supply port and the control port and to close the return port, and moveable to any position intermediate the first, second and third positions.

Still more preferably, the valve member may comprise a flapper extending into the first passage from the second passage.

Features of any example described herein may, wherever appropriate, be applied to any other examples of the present disclosure. Where reference is made to different examples, it should be understood that these are not necessarily distinct but may overlap.

### DETAILED DESCRIPTION

One or more non-limiting examples will now be described, by way of example only, with reference to the accompanying drawings, in which:

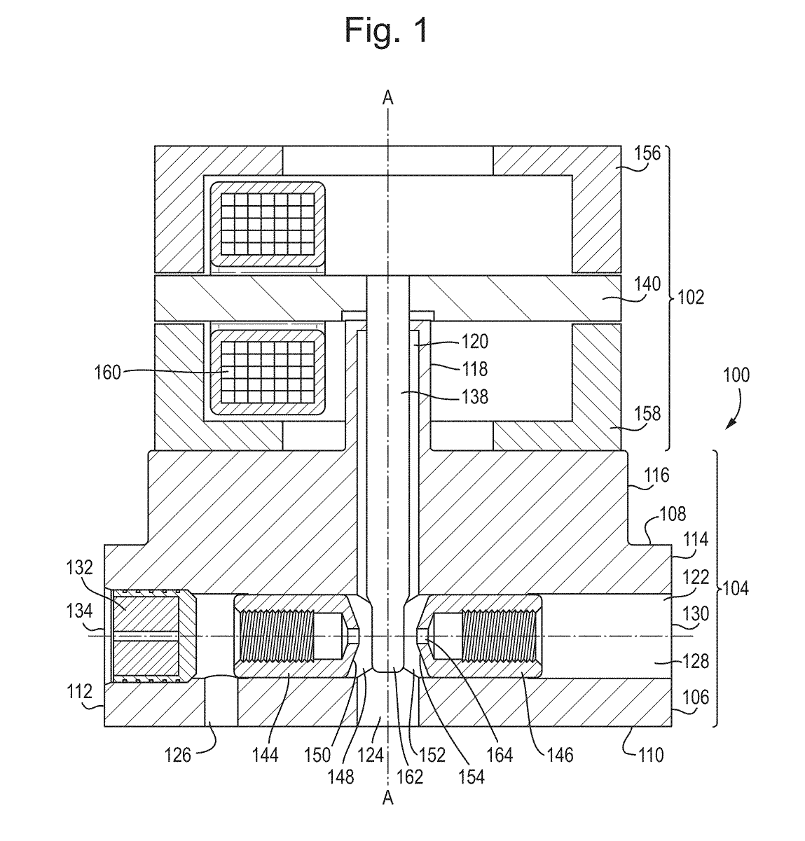

FIG. 1 is a cross-sectional view of a servovalve according to examples typical of the prior art;

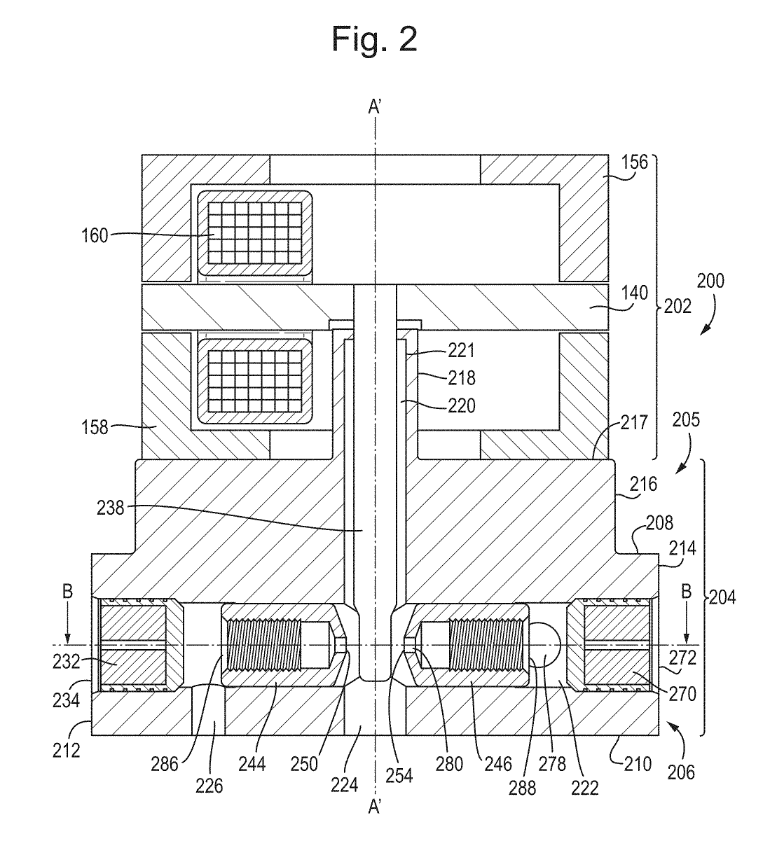

FIG. 2 is a cross-sectional view of a servovalve according to an example of the present disclosure;

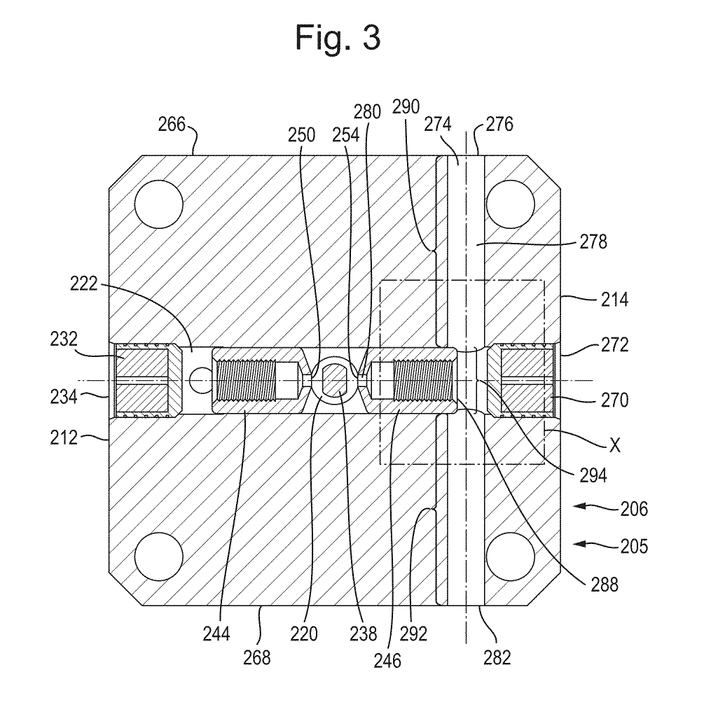

FIG. 3 is a cross-sectional view of the servovalve of FIG. 2 along line B-B;

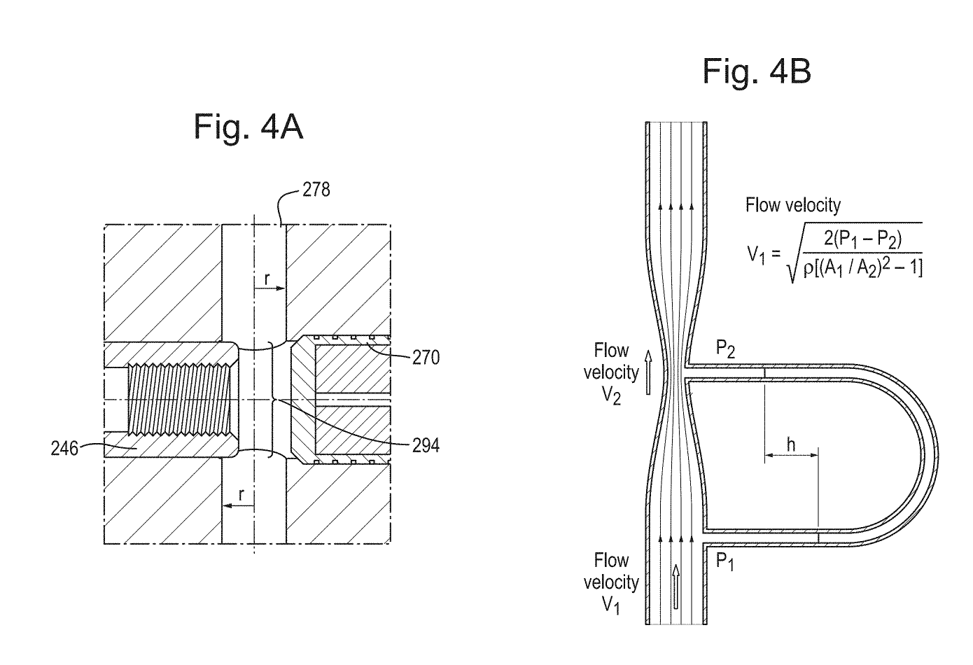

FIG. 4a is an enlarged view of the portion of the cross-sectional view of FIG. 3 shown in box “X”; and

FIG. 4b is schematic representation of the relative flow velocities and pressures occurring across the passages of FIG. 4a.

### DETAILED DESCRIPTION

As is known in the art, servovalves and, in particular, single stage pneumatic servovalves can be used for regulating flow of fluids such as air or other gases. Servovalves of this kind can be used, amongst other things, in aircraft air management systems such as engine bleed systems or cabin air conditioning systems. The servovalve is controlled by a power signal supplied to the coils of a torque motor. For reference, an example of one type of conventional servovalve is depicted in FIG. 1. The new valve body for a servovalve described herein may be used with the type of servovalve shown in FIG. 1, as illustrated in FIGS. 2 and 3 and described below, but is not limited to this, and may also be used with other types of servovalves. The servovalve depicted in FIG. 1 and FIGS. 2 and 3 is therefore one example of a servovalve with which the valve body as described later and shown in FIGS. 2 and 3 can be used.

FIG. 1 shows a cross section through a servovalve 100 comprising a first subsystem 102 for driving a second subsystem 104 for controlling the flow of a fluid such as air. The first subsystem comprises a torque motor. The servovalve 100 is assembled about a longitudinal axis A-A as shown in FIG. 1.

The second subsystem 104 comprises a box-shaped body 106 having a first square planar surface 108 centred on the longitudinal axis A-A, a second square planar surface 110, which forms the base of the box shaped body 106, centred on the longitudinal axis A-A and separated from the first square planar surface 108 in a first axial direction, and first to fourth side walls joining the first and second square planar surfaces 108, 110, wherein the first side wall 112 is opposite the second side wall 114 and the third and fourth side walls are not shown.

The second subsystem 104 further comprises a cylindrical body 116 which is centred on the longitudinal axis A-A and formed integrally with the box shaped body 106 extending from the first square planar surface 108 thereof in a second axial direction, opposite the first axial direction. A hollow cylindrical chimney 118 is formed integrally with the cylindrical body 116 and extends in the second axial direction therefrom along the longitudinal axis A-A.

A first cylindrical passage 122 extends from the first side wall 112 to the second side wall 114. A second cylindrical passage 120 extends through the hollow cylindrical chimney 118, the cylindrical body 116 and the box shaped body 106 along the longitudinal axis A-A and intersects the first cylindrical passage 122 perpendicular thereto. A control port 124 is provided in the second square planar surface 112 and extends axially in line with the second cylindrical passage 120. A supply port 126 is provided in the base 112 of the box shaped body 106 to one side of the control port 124 and extends from the base 112 parallel to the second cylindrical passage 120 to join with the first cylindrical passage 122. A return port 128 is formed by an open end 130 of the first cylindrical passage 122 at the second side wall 114. A Lee plug 132 is provided at an end 134 of the first cylindrical passage 122 opposite the open end 130, adjacent the first side wall 112 to seal the first cylindrical passage 122 from the external environment. As the open end 130 of the first cylindrical passage 122 adjacent the second side wall 114 functions as the return port 128, no Lee plug is provided at the open end 130.

The second subsystem 104 further comprises a moveable member or flapper 138 which is cylindrical in shape, and an armature plate 140 which is substantially rectangular in cross section. The armature plate 140 is mounted such that in its resting position, the longitudinal axis (not shown) thereof extends perpendicular to the longitudinal axis A-A and parallel to the first cylindrical passage 122. The flapper 138 extends along the longitudinal axis A-A, through the centre of the armature plate 140 and through the second cylindrical passage 120.

When the torque motor is not activated and the armature plate 140 is in its resting position, the flapper 138 extends into the second cylindrical passage 120 and is in line with the control port 124. First and second nozzles 144, 146 are provided in the first cylindrical passage 122 on either side of the flapper 138. First nozzle 144 is located between the control port 124 and the supply port 126. Second nozzle 146 is located between the control port 124 and the return port 128. With the flapper 138 in its resting position, the flapper 138 extends between the first nozzle 144 and the second nozzle 146, leaving a first gap 148 between an end 150 of the first nozzle 144 and the flapper 138, and a second gap 152 between an end 154 of the second nozzle 146 and the flapper 138. With the flapper 138 in this position the nozzle 144 is open and fluid or air may flow from the supply port 126 to the control port 124 and the return port 128.

The first subsystem 102 comprises a torque motor having a first pole piece 156, centred on the longitudinal axis A-A and arranged parallel to the armature plate 140 and spaced therefrom in the second axial direction, and a second pole piece 158 arranged parallel to the armature plate 140 and spaced therefrom in the first axial direction. The first subsystem 102 further comprises a coil 160 wrapped around the armature plate 140 on one side and spaced from the centre thereof. Permanent magnets (not shown) are also provided on opposite sides of the armature plate 140. The coil 160 is connected via lead wires (not shown) to a source of electricity (not shown) to thereby provide an electrical current to the coil 160.

The torque motor is an electromagnetic circuit such that in operation, current flowing through the coil 160 creates an electromagnetic force acting on the armature plate 140. In use, the armature plate 140 and flapper 138 rotate due to the current flowing through the coil 160.

This rotation changes the position of the end 162 of the flapper 138, moving it either towards the supply port 126 such that the flapper 138 abuts against the end 150 of the first nozzle 144 or towards the return port 128 such that the flapper 138 abuts against the end 154 of the second nozzle 146. When the flapper 138 abuts against the end 150 of the first nozzle 144, the supply port 126 is closed and fluid or air will flow from the control port 124 to the return port 128. When the flapper 138 abuts against the end 154 of the second nozzle 146, the return port 128 is closed and fluid or air will flow from the supply port 126 to the control port 124.

It will be understood that sand, dust particles or other contaminants present in the fluid or air in the external environment can flow into the first cylindrical passage 122 through the return port 128. The fluid or air containing the contaminants will then flow along the first cylindrical passage 122 into the second nozzle 146. As an opening 164 is provided in the end 154 of the second nozzle 146 adjacent the flapper 138, the contaminants may flow through the opening 164 such that the contaminants can become trapped and build up in the second gap 152. This may prevent the flapper 138 from contacting the end 154 of the second nozzle 146 and so prevent the closure of the return port 128.

It would be possible to remove at least some contaminants in the fluid or air flowing into the return port 128 by providing a filter (not shown) across the open end 130 of the first cylindrical passage 122. However, the provision of such a filter (especially if it became clogged or partially clogged by contaminants in use) would increase flow resistance in the servovalve such that performance of the servovalve would be impaired. The present disclosure therefore provides a solution to this problem.

A new valve body for a servovalve is now described with reference to FIGS. 2, 3, 4a and 4b. In the servovalve of the present disclosure, no pilot flow is required, as it is driven by a linear force motor. Typical flow rates of air through the valve system may be from 5 to 100 l/min (1.3 to 26.3 gpm) @ Δp 35 bar (500 psi) per land.

FIG. 2 shows a cross section through a servovalve 200 according to an example of the present disclosure. The servovalve 200 comprises a first subsystem 202 for driving a second subsystem 204. The first subsystem 202 corresponds to the first subsystem 102 of FIG. 1 and corresponding parts are given the same reference numbers as in FIG. 1.

The second subsystem 204 comprises a valve body 205 which comprises a box shaped body 206. FIG. 3 is a section through the box shaped body 206 of the second subsystem 204 along line A′-A′ shown in FIG. 2. As seen in FIGS. 2 and 3, the box shaped body 206 has first and second side walls arranged opposite each other on first and second sides 212, 214 of the valve body 205 and third and fourth side walls arranged opposite each other on third and fourth sides 266, 268 of the valve body 205 and extending between the first and second side walls 212, 214. The box shaped body 206 further comprises a first square planar surface 208 and a second square planar surface 210 (which forms a second planar surface 210 of the valve body 205) spaced apart in an axial direction and joined together by the side walls.

As in the example of FIG. 1, the valve body 205 further comprises a cylindrical body 216 which is centred on the longitudinal axis A′-A′ and formed integrally with the box shaped body 206 extending from the first square planar surface 208 thereof in a second axial direction, opposite the first axial direction. An end surface of the cylindrical body 216 removed from the box shaped body 206 forms a first planar surface 217 of the valve body 205. A hollow cylindrical chimney 218 is formed integrally with the cylindrical body 216 and extends in the second axial direction from the first planar surface 217 along the longitudinal axis A′-A′.

A second passage 220 which is cylindrical in the example shown extends through the hollow cylindrical chimney 218, the cylindrical body 216 and the box shaped body 206 along the longitudinal axis A′-A′ defining an annular wall 221. A first passage 222 which is cylindrical in the example shown extends from the first side 212 to the second side 214 and intersects the second cylindrical passage 220 substantially perpendicular thereto. A control port 224 is provided in the second planar surface 210 and extends axially in line with the second passage 220. A supply port 226 is provided in the second planar surface 210 of the valve body 205 to one side of the control port 224 and extends from the second planar surface 210 parallel to the second passage 220 to join with the first passage 222.

A first Lee plug 232 is provided at a first end 234 of the first passage 222 adjacent the first side 212 to seal the first passage 222 from the external environment. A further Lee plug 270 is provided at a second end 272 of the first passage 222 adjacent the second side 214 to seal the first passage 222 from the external environment. Thus, a straight stream of contaminants which flows a direction parallel to the longitudinal extent of the first passage may not enter the first passage in the manner described for the known example of FIG. 1.

A return port 274 is formed by a first open end 276 of a third passage 278 which extends substantially perpendicular to both the first and second passages 220, 222 from the third side 266 through the box shaped body 206 and across the first passage 222 to the fourth side 268. The return port 274 is further formed by a second open end 282 of the third passage 278 The further Lee plug 270 is positioned between the second end 272 of the first passage 222 and the third passage 278 and does not overlap with the third passage 278.

As in the example of FIG. 1, the second subsystem 204 further comprises a moveable member or flapper 238 which is cylindrical in shape, and an armature plate 140 which is substantially rectangular in cross section. The armature plate 140 is mounted such that in its resting position, the longitudinal axis (not shown) thereof extends perpendicular to the longitudinal axis A′-A′ and parallel to the first passage 222. The flapper 238 extends along the longitudinal axis A′-A′, through the centre of the armature plate 140 and into the second passage 220 and the first passage 222.

When the torque motor is not activated and the armature plate 140 is in its resting position, the flapper 238 is in line with the control port 224. First and second nozzles 244, 246 are provided in the first passage 222 on either side of the flapper 238. First nozzle 244 is located on a first side of the flapper 238 between the control port 224 and the supply port 226 so that a first end 250 thereof is substantially in line with the annular wall 221 of the second passage 220. A second end 286 of the first nozzle 244 is substantially in line with the point at which the supply port 226 meets the first passage 222.

When the torque motor is not activated and the armature plate 240 is in its resting position, the flapper 238 does not contact either the first or second nozzle 244, 246 and so fluid or gas may flow from the supply port 226 to the control port 224 and the return port 274. When the torque motor is activated, depending on the current applied thereto, the flapper 238 may be moved to contact the first nozzle 244, thus closing the supply port 226 so there will be no flow of fluid or gas into the first passage 222 or may be moved to contact the second nozzle 246 so as to close the return port 274, thus allowing flow from the supply port 226 to the control port 224 only. It will be understood that depending on the current applied to the torque motor, the flapper 238 may be moved to any position between contacting the first nozzle 244 and contacting the second nozzle 246.

Second nozzle 246 is located on the other (second) side of the flapper 238. A first end 254 thereof is substantially in line with the annular wall 221 of the second passage 220. A second end 288 of the second nozzle 246 is positioned such that the second nozzle 246 extends across a portion of the third passage 278. As seen more clearly in FIG. 3, in the example of the disclosure as shown, the second nozzle 246 is positioned to extend over approximately 25% of the diameter of the third passage 278.

As seen in FIGS. 4a and 4b, the available flow volume within the third passage 278 is varied by the overlap of the second nozzle 246 with the third passage 278. Thus, a first portion 290 of the third passage 278, extending from the first open end 276 of the third passage 278 to the intersection with the first passage 222, has a constant cross sectional area, A=πr², where the radius r of the third passage 278 is constant. In the same way, a third portion 292 of the third passage 278, extending from the second open end 282 of third passage 278 to the intersection with the first passage 222, has a constant cross sectional area, A=πr². The cross sectional area of a second portion 294 of the third passage 278 which intersects with the first passage 222 is reduced by approximately 25% relative to the cross sectional area A of the first portions 290, 292 due to the second nozzle 246 overlapping with the third passage 278.

The reduced flow area of the second portion 294 will cause flow velocity of fluid through the second portion 294 to increase relative to flow velocity of the fluid in the first and third portions 290, 292, thus causing the pressure within the second nozzle 246 to be reduced as is known from the Venturi effect and as shown in FIG. 4b. Thus, suction will be created within the second nozzle 246, thus reducing the likelihood of any contaminated fluid or air flowing along the third and fourth cylindrical passages 278, 284 flowing into the nozzle 246.

A flow orifice 280 having a smaller cross sectional area than the cross sectional area of the first passage 222 is provided in the first end 254 of the second nozzle 246. The flow orifice 280 represents the smallest cross sectional area for return fluid flow from the return port 274. To further reduce the possibility of any fluid flow from the return port 274 entering the first passage 222, the cross sectional area A of the first and third portions 290, 292 of the third passage 278 is at least ten times greater than the cross sectional area of the flow orifice 280. This means that the reduction in pressure described above will only occur across the second nozzle 246, thus providing the advantageous effect described above.

It will be appreciated by those skilled in the art that the present disclosure has been illustrated by describing one or more specific examples thereof, but is not limited to these examples; many variations and modifications are possible, within the scope of the accompanying claims.

1. A valve body for a servovalve, the valve body comprising:
a first surface;
a second surface offset from the first surface;
a first passage extending through the body from a first side of the body to a second side thereof and located between the first and second surfaces;
a second passage extending from the first surface towards the second surface and intersecting the first passage;
a supply port joined with the first passage;
a control port joined with the first passage;
a return port joined with the first passage,
wherein the return port comprises a third passage extending through the body from a third side of the body to a fourth side thereof, and wherein the third passage is located between the first and second surfaces and intersects with the first passage.

2. The valve body as claimed in claim 1, wherein the first passage and/or the second passage and/or the third passage is substantially straight.

3. The valve body as claimed in claim 1, wherein the first passage extends about a first axis, the second passage extends about a second axis and the third passage extends about a third axis, and
wherein the first axis and the third axis are located in parallel planes.

4. The valve body as claimed in claim 1, wherein the third passage intersects the first passage at an angle of between 45° and 135°.

5. The valve body as claimed in claim 1, wherein the third passage intersects the first passage at an angle of between 85° and 95°, or wherein the third passage intersects the first passage substantially perpendicular thereto.

6. The valve body as claimed in claim 4, wherein the third passage intersects the first passage and is substantially perpendicular thereto.

7. The valve body as claimed in claim 1, wherein the first passage is sealed from an external environment at the first and second sides of the body.

8. The valve body as claimed in claim 1, wherein a flow orifice having a smaller diameter than a diameter of the first passage is provided in the first passage between the second and third passages, and wherein a cross sectional flow area of the third passage is at least ten times greater than a cross sectional area of the flow orifice.

9. The valve body as claimed in claim 1, wherein the third passage comprises:
a first portion extending between the third side of the body and the first passage and having a first cross sectional flow area;
a second portion extending across the first passage; and
a third portion extending between the first passage and the fourth side of the body and having the first cross sectional flow area,
wherein a second cross sectional flow area in at least part of the second portion is less than the first cross sectional flow area.

10. The valve body as claimed in claim 8, wherein an obstruction protrudes from the first passage across part of the second portion of the third passage so as to reduce a cross sectional flow area in the second portion of the third passage to the second cross sectional flow area.

11. The valve body as claimed in claim 1, wherein the control port is in line with the second passage.

12. The valve body as claimed in claim 10, further comprising:
a first nozzle provided in the first passage between the supply port and the control port; and
a second nozzle provided in the first passage, a first end of the second nozzle being adjacent to the control port and a second end of the second nozzle protruding from the first passage into the third passage.

13. A servovalve comprising:
a torque motor; and
a valve body as claimed in claim 1.

14. A servovalve as claimed in claim 12, further comprising a valve member movable between a first position to open the supply port, control port and return port, a second position to close the supply port, a third position to open the supply port and the control port and to close the return port, and moveable to any position intermediate the first, second and third positions.

15. A servovalve as claimed in claim 13, wherein the valve member comprises a flapper extending into the first passage from the second passage.
